(19) United States
(12) Patent Application Publication
(10) Pub. No.: US 2026/0312184 A1
(43) Pub. Date: Oct. 8, 2026

(54) BATTERY MODULE

(71) Applicant: TOYOTA JIDOSHA KABUSHIKI KAISHA, Toyota-shi (JP)

(72) Inventor: Yuichi NAGAMATSU, Toyota-shi (JP)

(73) Assignee: TOYOTA JIDOSHA KABUSHIKI KAISHA, Toyota-shi (JP)

(21) Appl. No.: 19/556,468

(22) Filed: Mar. 4, 2026

(30) Foreign Application Priority Data
Apr. 7, 2025 (JP) 2025-063218

(51) Int. Cl. H01M 10/658; H01M 10/647; H01M 50/209; H01M 50/249; H01M 50/264; H01M 50/293

(52) U.S. Cl. CPC H01M 10/658; H01M 10/647; H01M 50/209; H01M 50/249; H01M 50/264; H01M 50/293; H01M 2200/101

(57) ABSTRACT

Multiple battery cells arranged along a predetermined 1 direction, multiple heat insulating materials provided between and contacting adjacent battery cells, and a restraining member exerting force in a direction of bringing the battery cells into contact with the heat insulating material thereupon. The heat insulating material includes a high melting point portion, a high melting point portion along a 2 direction orthogonal to the 1 direction and a low melting point portion having a melting point lower than the high melting point portion, and one of the two heat insulating materials sandwiching the battery cell from both sides in the 1 direction, the high melting point portion is on one side of the second direction from the low melting point portion, and the other of the two heat insulating materials, the high melting point portion is on the other side of the second direction from the low melting point portion.

### CROSS-REFERENCE TO RELATED APPLICATION

This application claims priority to Japanese Patent Application No. 2025-063218 filed on Apr. 7, 2025. The disclosure of the above-identified application, including the specification, drawings, and claims, is incorporated by reference herein in its entirety.

### BACKGROUND

### 1. Technical Field

The present disclosure relates to a battery module.

### 2. Description of Related Art

Japanese Unexamined Patent Application Publication (Translation of PCT Application) No. 2023-524706 (JP 2023-524706 A) discloses a battery module including a plurality of battery cells arrayed along a predetermined direction, and a plurality of heat insulating materials provided between adjacent battery cells and in contact with the respective battery cells. The outside of each of the heat insulating materials is made of a material having a low melting point, and the inside of each of the heat insulating materials is made of a heat resistant material having a melting point higher than the outside.

### SUMMARY

When one of the battery cells undergoes thermal runaway, the outside of the two heat insulating materials located on both sides of this battery cell melts, and the heat resistant material located inside these two heat insulating materials comes into contact with this battery cell. At this time, the contact area between the battery cell that has undergone thermal runaway and the heat resistant materials located on both sides of this battery cells tends to increase. Accordingly, the heat of the battery cell that has undergone thermal runaway is easily transferred to the other battery cells via the heat resistant materials located on both sides.

In view of the above, it is an object of the present disclosure to provide a battery module that does not readily transfer the heat of a battery cell that has undergone thermal runaway to another battery cell.

A battery module according to a first aspect includes a plurality of battery cells arrayed along a first direction that is predetermined, a plurality of heat insulating materials provided between the battery cells that are adjacent, in contact with respective battery cells, and a restraining member that exerts a force on the battery cells in a direction in which the battery cells are brought into contact with the heat insulating materials, in which the heat insulating materials include a high melting point portion, and a low melting point portion that is aligned with the high melting point portion along a second direction orthogonal to the first direction and of which a melting point is lower than the high melting point portion, and in one of two of the heat insulating materials sandwiching each of the battery cells from both sides in the first direction, the high melting point portion is located further toward one side in the second direction than the low melting point portion, and in another of the two of the heat insulating materials, the high melting point portion is located further on another side in the second direction than the low melting point portion.

In the battery module according to the first aspect, when one battery cell undergoes thermal runaway, for example, heat is transferred from this battery cell to two heat insulating materials located on both sides of this battery cell. Accordingly, the low melting point portions of the two heat insulating materials may be melted. In one of the two heat insulating materials sandwiching the battery cell from both sides in the first direction, the high melting point portion is located further on one side in the second direction than the low melting point portion, and on the other side of the two heat insulating materials, the high melting point portion is located further on the other side in the second direction than the low melting point portion. Accordingly, when the low melting point portions of the two heat insulating materials are melted, the battery cell that has undergone thermal runaway is inclined with respect to the adjacent battery cells, and accordingly thermal resistance between the battery cell that has undergone thermal runaway and the battery cells that are adjacent readily increases. Accordingly, in the battery module according to the first aspect, transfer of the heat of the battery cell that has undergone thermal runaway to another battery cell can be made to occur less readily.

With the battery module according to a second aspect, in the first aspect, as viewed along a third direction orthogonal to the first direction and the second direction, an end of a battery cell on the one side in the second direction is located on the one side from a boundary portion between the high melting point portion and the low melting point portion, and also an end of a battery cell on the other side in the second direction is located on the other side from the boundary portion.

In the battery module according to the second aspect, when the low melting point portions of the two heat insulating materials are melted, the battery cells that have undergone thermal runaway tend to incline with respect to the battery cells that are adjacent.

With the battery module according to a third aspect, in the first or second aspect, the first direction is a lateral direction, and the second direction is an up-down direction.

In the battery module according to the third aspect, when the low melting point portions of the two heat insulating materials are melted, the battery cell that has undergone thermal runaway is inclined with respect to the battery cells that are adjacent, utilizing gravity. Accordingly, the battery cell that has undergone thermal runaway tends to incline with respect to the battery cells that are adjacent.

With the battery module according to a fourth aspect, in the first or second aspect, the first direction and the second direction are lateral directions.

In the battery module according to the fourth aspect, when the low melting point portion is melted, the position of the high melting point portion forming a pair with this low melting point portion in the up-down direction is not readily changed due to the melting of the low melting point portion. Thus, the action of the battery cell that has undergone thermal runaway becoming inclined with respect to the battery cells that are adjacent is easily stabilized.

With the battery module according to a fifth aspect, in any one of the first to fourth aspects, a shape of a cell case of each of the battery cells is a rectangular cuboid shape.

In the battery module according to the fifth aspect, when the battery cell that has undergone thermal runaway is inclined, the contact area between the battery cell that has undergone thermal runaway and the battery cells that are adjacent tends to be small.

As described above, the battery module according to the present disclosure has an excellent effect of making it difficult to transfer heat of the battery cell that has undergone thermal runaway to other battery cells.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a battery pack including a battery module according to a first embodiment;

FIG. 2 is a schematic exploded perspective view of some components of a battery module;

FIG. 3 is a schematic side view of a portion of a battery module;

FIG. 4 is a schematic plan view of a portion of a battery module;

FIG. 5 is a schematic side view of a portion of a battery module when one battery cell is in thermal runaway;

FIG. 6 is a schematic side view of a portion of a battery module when thermal runaway has progressed from the state of FIG. 5;

FIG. 7 is a schematic side view of a part of a battery module according to a second embodiment;

FIG. 8 is a schematic plan view of a portion of a battery module; and

FIG. 9 is a schematic plan view of a part of a battery module when one battery cell runs out of heat.

### DETAILED DESCRIPTION OF EMBODIMENTS

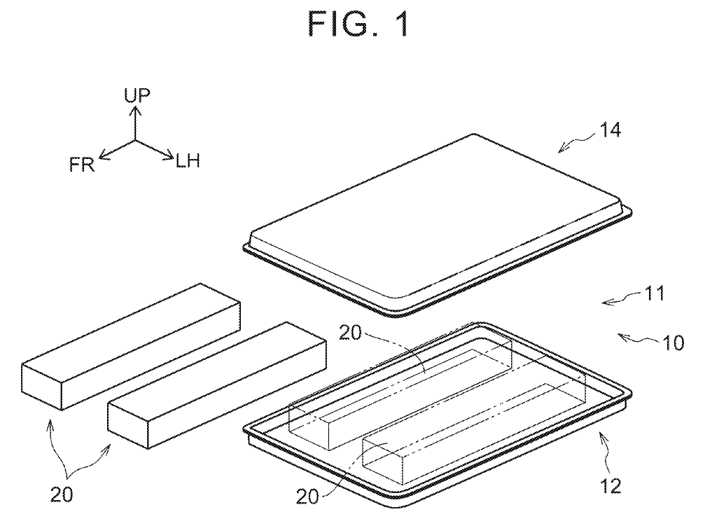

Hereinafter, a battery module according to a first embodiment will be described with reference to FIGS. 1 to 6. Note that the arrows UP, the arrow FR, and the arrow LH in the drawings respectively indicate an upper side in the vehicle up-down direction, a front side in the vehicle front-rear direction, and a left side in the vehicle left-right direction.

The battery module 20 of the present embodiment is a part of the battery pack 10 shown in FIG. 1. The battery pack 10 is mounted on a vehicle. The vehicles of the present embodiment are battery electric vehicle (BEV: Battery Electric Vehicle).

The battery pack 10 of the present embodiment includes a battery case 11 and two battery modules 20. The electric power of the battery pack 10 (battery cell 23) is supplied to, for example, an electric motor (not shown) that applies a driving force to the front wheels and the rear wheels of the vehicle.

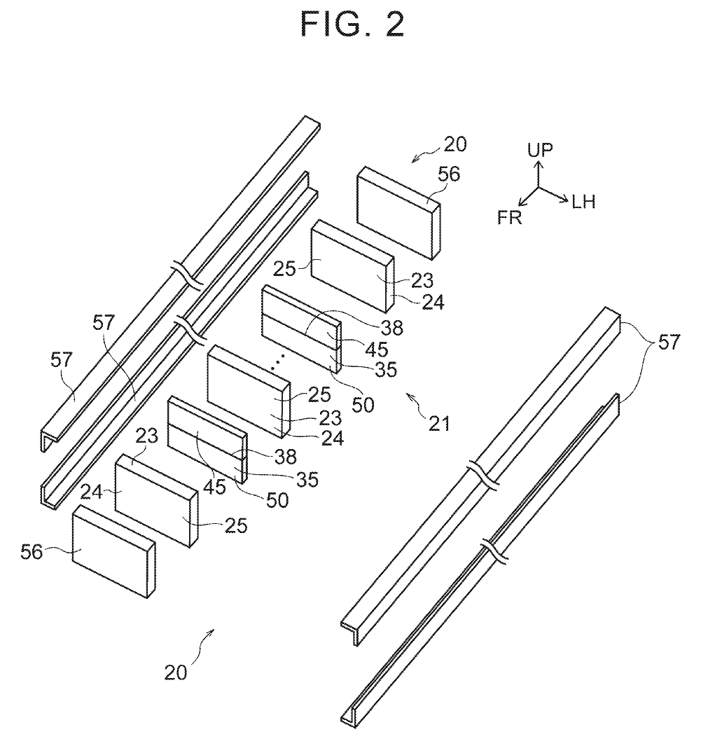

As shown in FIGS. 1 and 2, the battery case 11 includes a lower case 12 and an upper case 14.

The lower case 12 is a hollow body having an opening formed in an upper surface thereof. The upper case 14 is a hollow body having an opening formed in a lower surface thereof.

As shown in FIG. 1, two battery modules 20 are provided inside the lower case 12. The battery modules 20 are arranged in the left-right direction.

As shown in FIG. 2, the battery module 20 includes a battery stack 21, a pair of end plates 56, and four restraining members 57.

The battery stack 21 extending in the front-rear direction in a plan view is in the front-rear direction (first direction). A plurality of battery cells 23 arranged along the lateral direction and a plurality of heat insulating materials 35 positioned between adjacent battery cells 23 are provided. Note that although only a few battery cells 23 are illustrated in FIGS. 2 to 6 for convenience, the battery stack 21 actually includes a large number of battery cells 23 (for example, 30 battery cells). Each battery cell 23 has the same specifications. In addition, although only a few of the heat insulating materials 35 are illustrated in FIGS. 2 to 6 for convenience, the battery stack 21 actually includes a large number of the heat insulating materials 35.

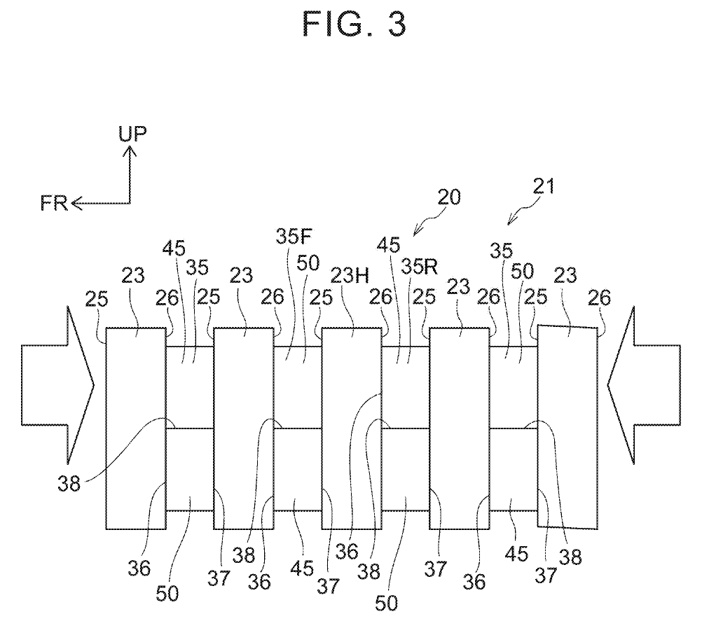

As shown in FIGS. 2 and 3, the metal cell case 24 constituting the outer shape of the battery cell 23 which is a lithium ion battery has a rectangular parallelepiped shape. That is, the cell case 24 includes a front plate portion 25, a rear plate portion 26, a pair of side plate portions, a bottom plate portion, and an upper plate portion. The front plate portion 25 and the rear plate portion 26 have substantially the same shape. The front shape of the front plate portion 25 and the rear plate portion 26 is a rectangle having a lateral dimension larger than the vertical dimension. Further, each battery cell 23 has a positive electrode and a negative electrode (both of which are not shown).

As shown in FIGS. 2 and 3, a heat insulating material 35 is provided between adjacent battery cells 23 (cell case 24). The heat insulating material 35 is an integrally molded product made of resin. The heat insulating material 35 has an electrical insulating property and a higher heat insulating property than the cell case 24.

The heat insulating material 35 has a substantially rectangular parallelepiped shape. The upper and lower dimensions and the left and right widths of the heat insulating material 35 are slightly smaller than those of the battery cells 23. The front surface 36 and the rear surface 37 of the heat insulating material 35 are planes orthogonal to the front-rear direction.

The heat insulating material 35 has two parts integrated with each other. That is, the heat insulating material 35 has a high melting point portion 45 and a low melting point portion 50.

The high melting point portion 45 is made of a material having a high melting point. For example, the high melting point portion 45 is made of a heat resistant material (for example, a ceramic-based heat-insulating material) having a melting point higher than the temperature (600 to 900°) at which the battery cell 23 runs out of heat. Further, the thermal conductivity of the high melting point portion 45 is low. The low melting point portion 50 is made of a material having a melting point lower than that of the high melting point portion 45. For example, the low melting point portion 50 is made of a heat resistant material (for example, polypropylene) having a melting point lower than the temperature (600 to 900°) at which the battery cell 23 runs out of heat. The high melting point portion 45 and the low melting point portion 50 are integrated at a boundary surface (boundary portion) 38. The outer shapes of the high melting point portion 45 and the low melting point portion 50 are substantially the same.

Positions of the high melting point portion 45 and the low melting point portion 50 in the up-down direction (second direction) of each heat insulating material 35 are changed every other. That is, as shown in FIGS. 3 to 6, in each of the odd-numbered heat insulating materials 35 in order from the front, the high melting point portion 45 constitutes the upper half portion of the heat insulating material 35, and the low melting point portion 50 constitutes the lower half portion of the heat insulating material 35. On the other hand, in each of the even-numbered heat insulating materials 35 sequentially from the front, the low melting point portion 50 constitutes the upper half portion of the heat insulating material 35, and the high melting point portion 45 constitutes the lower half portion of the heat insulating material 35.

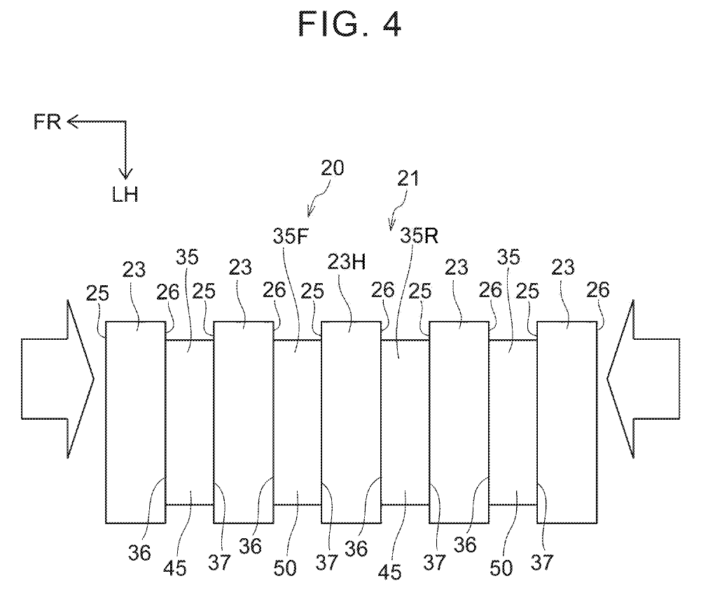

As shown in FIGS. 3 and 4, the heat insulating materials 35 are in contact with the front plate portion 25 and the rear plate portion 26 of the cell case 24 of the battery cell 23 adjacent thereto.

As shown in FIG. 2, the battery module 20 includes a pair of front and rear end plates 56. The front end plate 56 is located immediately before the front-most battery cell 23, and the rear end plate 56 is located immediately after the rear-most battery cell 23.

As shown in FIG. 2, the four restraining members 57 extend in the front-rear direction, and the cross-sectional shape thereof is substantially L-shaped. Each of the restraining members 57 is fixed to the front and rear end plates 56 while covering the four corners of each of the battery cells 23 (the cell case 24) and the end plate 56. As a result, the front-rear length of each restraining member 57 is shorter than that in the free state. That is, the front and rear end plates 56 are pulled by the restraining members 57 in a direction approaching each other, and thereby the front and rear end plates 56 sandwich the battery stack 21 from the front and rear sides (see arrows in FIGS. 3 to 6). Therefore, the cell case 24 and the heat insulating material 35 adjacent to each other in the front-rear direction come into surface contact with each other in the front-rear direction with a strong force. At this time, when the battery module 20 is viewed from the left-right direction (third direction), as shown in FIG. 3, the upper end of each battery cell 23 is positioned above the boundary surface 38 of each heat insulating material 35, and the lower end of each battery cell 23 is positioned below the boundary surface 38 of each heat insulating material 35.

In this way, the battery stack 21 and the end plate 56 are integrated by the restraining member 57. That is, the battery module 20 including the battery stack 21, the pair of end plates 56, and the four restraining members 57 is completed.

As shown in FIG. 1, each battery module 20 is housed inside the lower case 12, and each battery module 20 is fixed to the bottom of the lower case 12. Further, the entire lower surface of the outer peripheral portion of the upper case 14 is placed on the entire upper surface of the outer peripheral portion of the lower case 12 that houses the two battery modules 20 via a sealing material (not shown), and the lower case 12 and the upper case 14 are fixed to each other. As a result, the battery pack 10 is completed. Further, the battery case 11 of the completed battery pack 10 is supported by the vehicle body skeleton member of the vehicle.

### Action and Effect

Next, the operation and effects of the first embodiment will be described.

For example, when an internal short circuit occurs in any one of the battery cells 23 of the battery module 20, the battery cells 23 may be thermally runaway. For example, it is assumed that the battery cells indicated by reference numeral 23H in FIGS. 3 to 6 are thermally runaway.

When the battery cell 23H thermally runs out, heat is applied from the battery cell 23H to the two heat insulating materials 35 located on both sides of the battery cell 23H. In the following explanation, the heat insulating material 35 positioned immediately before the battery cell 23H is called a heat insulating material 35F, and the heat insulating material 35 positioned immediately after the battery cell 23H is called a heat insulating material 35R.

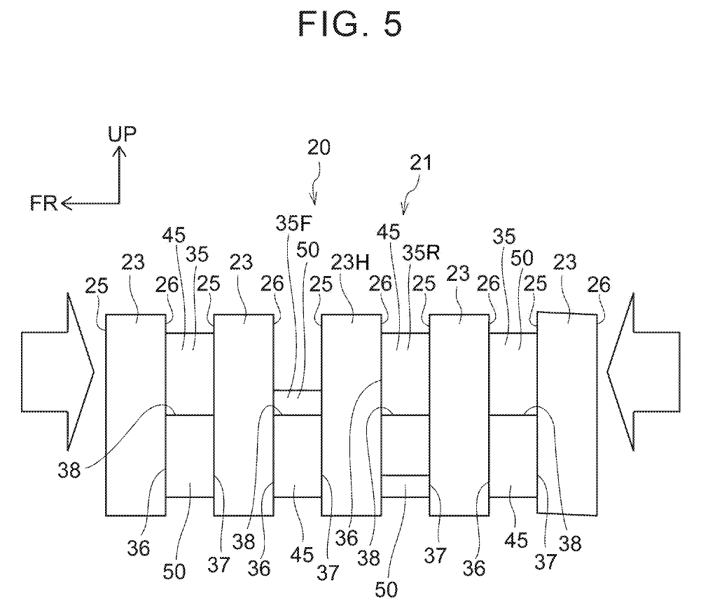

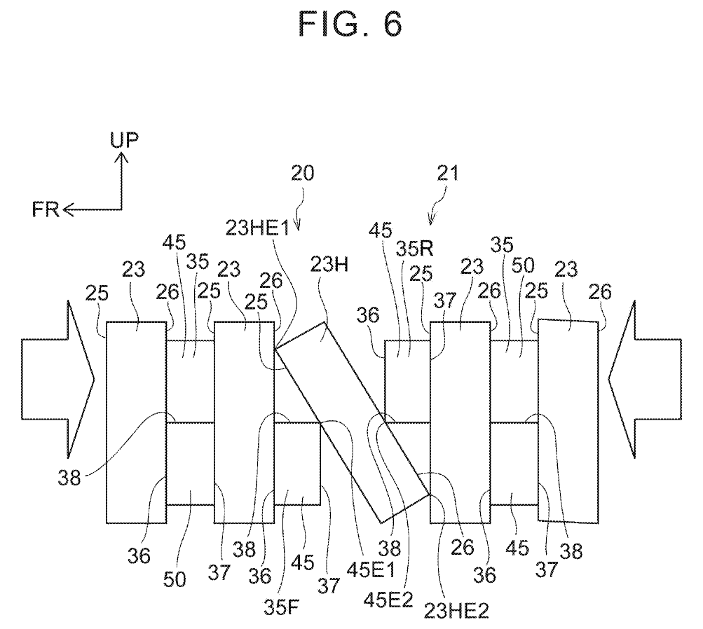

As described above, the melting point of the low melting point portion 50 is lower than that of the high melting point portion 45. Therefore, as shown in FIG. 5, the low melting point portion 50 of the heat insulating material 35F, 35R starts to melt due to the heat transferred from the battery cell 23H to the heat insulating material 35F, 35R, while the high melting point portion 45 of the heat insulating material 35F, 35R does not melt. When heat is further transferred from the battery cell 23H to the heat insulating material 35F, 35R, as shown in FIG. 6, the low melting point portion 50 of the heat insulating material 35F, 35R is completely melted, while the high melting point portion 45 of the heat insulating material 35F, 35R is not melted. Therefore, the area occupied by the low melting point portion 50 of the heat insulating material 35F, 35R becomes a space.

Therefore, as shown in FIG. 6, the heat insulating material 35F, 35R is inclined with respect to the battery cell 23H when the restraining members 57 are subjected to the force generated by the restraining members through the heat insulating material 35F, 35R. The cell case 24 of each battery cell 23 has a rectangular parallelepiped shape. Therefore, the front plate portion 25 of the battery cell 23H is in line contact with the rear upper end corner portion 45E1 of the high melting point portion 45 of the heat insulating material 35F, and the rear plate portion 26 of the battery cell 23H is in line contact with the front lower end corner portion 45E2 of the high melting point portion 45 of the heat insulating material 35R. Further, the upper end corner portion 23HE1 on the front side of the battery cell 23H contacts the rear plate portion 26 of the battery cell 23 positioned immediately before the heat insulating material 35F. The rear lower end corner portion 23HE2 of the battery cell 23H contacts the front plate portion 25 of the battery cell 23 located immediately after the heat insulating material 35R. Further, a gap is formed between the battery cell 23H and the two battery cells 23 located on both front and rear sides of the battery cell 23H, and a gap is formed between the battery cell 23H and the heat insulating material 35F, 35R.

As described above, when the battery module 20 is viewed from the left-right direction, the upper end of each battery cell 23 is positioned above the boundary surface 38 of each heat insulating material 35, and the lower end of each battery cell 23 is positioned below the boundary surface 38 of each heat insulating material 35. Further, when the low melting point portion 50 melts, the battery cell 23H tilts while utilizing gravitational force applied thereto. Therefore, the battery cell 23H is easily inclined with respect to the heat insulating material 35F, 35R in a side view.

Here, as shown in FIGS. 3 and 4, when the battery cell 23H is in surface contact with the heat insulating material 35F, 35R, the contact area between the front plate portion 25 of the battery cell 23H and the heat insulating material 35F and the contact area between the rear plate portion 26 of the battery cell 23H and the heat insulating material 35R are defined as A0. On the other hand, the contact area between the front plate portion 25 of the battery cell 23H and the rear upper end corner portion 45E1 of the heat insulating material 35F and the contact area between the rear plate portion 26 of the battery cell 23H and the front lower end corner portion 45E2 of the heat insulating material 35R shown in FIG. 6 are defined as A1. Here, the value is A0 > A1, and the value obtained by dividing A1 by A0 is an extremely small value. Further, a contact area between the upper end corner portion 23HE1 on the front side of the battery cell 23H and the rear plate portion 26 of the battery cell 23 positioned immediately before the heat insulating material 35F, and a contact area between the lower end corner portion 23HE2 on the rear side of the battery cell 23H and the front plate portion 25 of the battery cell 23 positioned immediately after the heat insulating material 35R are defined as A2. A2 is smaller. For example, A2 is much smaller than A0.

In this way, the contact area A1 between the battery cell and the heat insulating material 35F, 35R and the contact area A2 between the battery cell 23H and the two battery cells 23 located on both front and rear sides of the battery cell 23H in FIG. 6 are both very small in. Therefore, the amount of heat directly transferred from the battery cell 23H to the two battery cells 23 located on both front and rear sides of the battery cell 23H is small. Furthermore, the amount of heat transferred from the battery cell 23H to the two battery cells 23 located on both front and rear sides of the battery cell 23H via the heat insulating material 35F, 35R is also small. That is, the thermal resistivity between the battery cell 23H and the two battery cells 23 located on both front and rear sides of the battery cell 23H is very large. Therefore, when one battery cell 23(23H) undergoes a thermal runaway, a thermal chain is unlikely to occur between the plurality of battery cells 23.

It is to be noted that the inventors have experimentally confirmed that the larger the inclination angle of the battery cell 23H in the side view, the larger the gap between the battery cell 23H and the two battery cells 23 located on both front and rear sides of the battery cell 23H, and the gap between the battery cell 23H and the heat insulating material 35F, 35R. Then, it was confirmed that the thermal resistivity between the battery cell 23H and the two battery cells 23 located on both front and rear sides of the battery cell 23H increases.

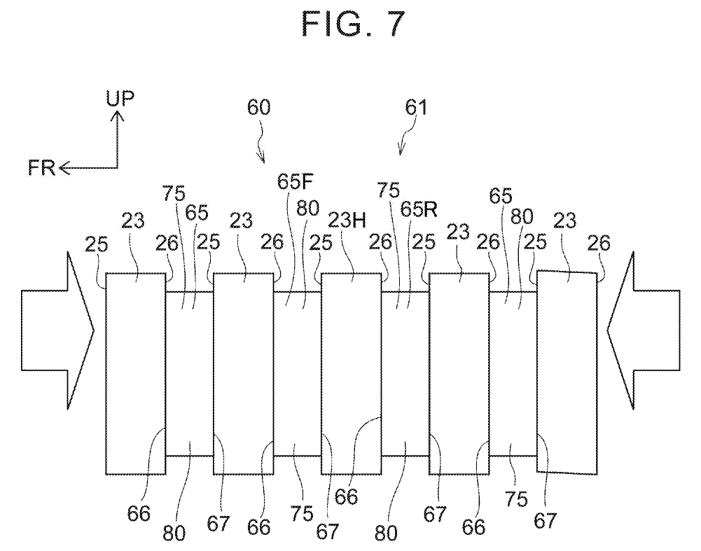

Next, a second embodiment of the present disclosure will be described with reference to FIGS. 7 to 9. The same components as those in the first embodiment are denoted by the same reference numerals, and a detailed description thereof will be omitted.

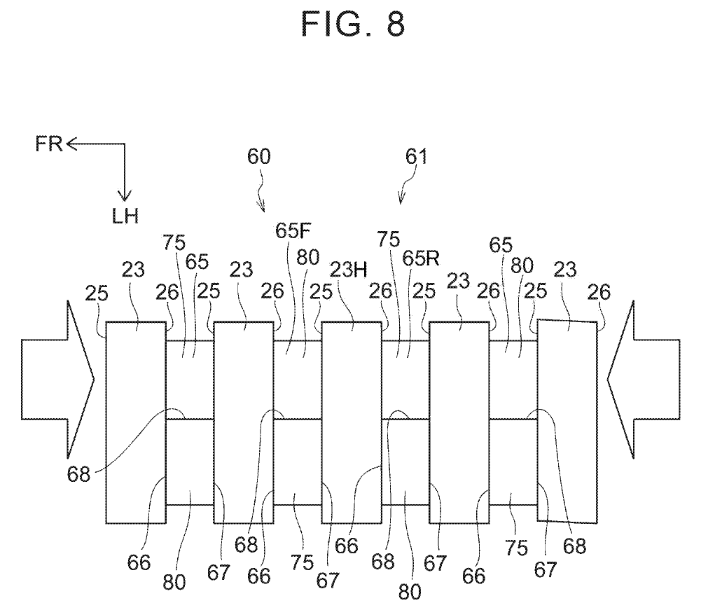

As shown in FIGS. 7 and 8, a heat insulating material 65 is provided between adjacent battery cells 23. The heat insulating material 65 is an integrally molded product made of resin. The heat insulating material 65 has an electrical insulating property and a heat insulating property higher than that of the cell case 24 of the battery cell 23.

The shape of the heat insulating material 65 is substantially the same as that of the heat insulating material 35. The front surface 66 and the rear surface 67 of the heat insulating material 65 are planes orthogonal to the front-rear direction.

The heat insulating material 65 has two parts integrated with each other. That is, the heat insulating material 65 has a high melting point portion 75 and a low melting point portion 80.

The high melting point portion 75 is made of a material having a high melting point. The low melting point portion 80 is made of a material having a melting point lower than that of the high melting point portion 75. The high melting point portion 75 and the low melting point portion 80 are integrated at a boundary surface (boundary portion) 68. The outer shapes of the high melting point portion 75 and the low melting point portion 80 are substantially the same. The constituent material of the high melting point portion 75 is the same as that of the high melting point portion 45, and the constituent material of the low melting point portion 80 is the same as that of the low melting point portion 50.

The left-right direction (second direction) of the high melting point portion 75 and the low melting point portion 80 of each heat insulating material 65. The position in the lateral direction) changes every other position. That is, as shown in FIG. 8, in each heat insulating material 65 of the odd number in order from the front, the high melting point portion 75 constitutes the right half of the heat insulating material 65, the low melting point portion 80 constitutes the left half of the heat insulating material 65. On the other hand, in each heat insulating material 65 of the even number in order from the front, the low melting point portion 80 constitutes the right half of the heat insulating material 65, the high melting point portion 75 constitutes the left half of the heat insulating material 65.

As shown in FIGS. 7 and 8, the heat insulating materials 65 are in contact with the front plate portion 25 and the rear plate portion 26 of the cell case 24 of the battery cell 23, respectively.

Also in the battery module 60, the front and rear end plates 56 (not shown in FIGS. 7 to 9) are pulled by the restraining members 57 (not shown in FIGS. 7 to 9) in a direction approaching each other. As a result, the front and rear end plates 56 sandwich the battery stack 61 including the battery cells 23 and the heat insulating material 65 from the front and rear sides. Therefore, the cell case 24 and the heat insulating material 65 adjacent to each other in the front-rear direction come into surface contact with each other in the front-rear direction with a strong force. When the battery module 60 is viewed in the up-down direction (third direction) at this time, as shown in FIG. 8, the right end of each battery cell 23 is positioned to the right of the boundary surface 68 of each heat insulating material 65, and the left end of each battery cell 23 is positioned to the left of the boundary surface 68 of each heat insulating material 65.

In this way, the battery stack 61 and the end plate 56 are integrated by the restraining member 57. That is, the battery module 60 including the battery stack 61, the pair of end plates 56, and the four restraining members 57 is completed.

### Action and Effect

Next, the operation and effects of the second embodiment will be described.

For example, when an internal short circuit occurs in any one of the battery cells 23 of the battery module 20, the battery cells 23 may be thermally runaway. For example, it is assumed that the battery cells indicated by reference numeral 23H in FIGS. 7 and 8 are thermally runaway.

When the battery cell 23H thermally runs out, heat is applied from the battery cell 23H to the two heat insulating materials 65 located on both sides of the battery cell 23H. In the following explanation, the heat insulating material 65 positioned immediately before the battery cell 23H is referred to as a heat insulating material 65F, and the heat insulating material 65 positioned immediately after the battery cell 23H is referred to as a heat insulating material 65R.

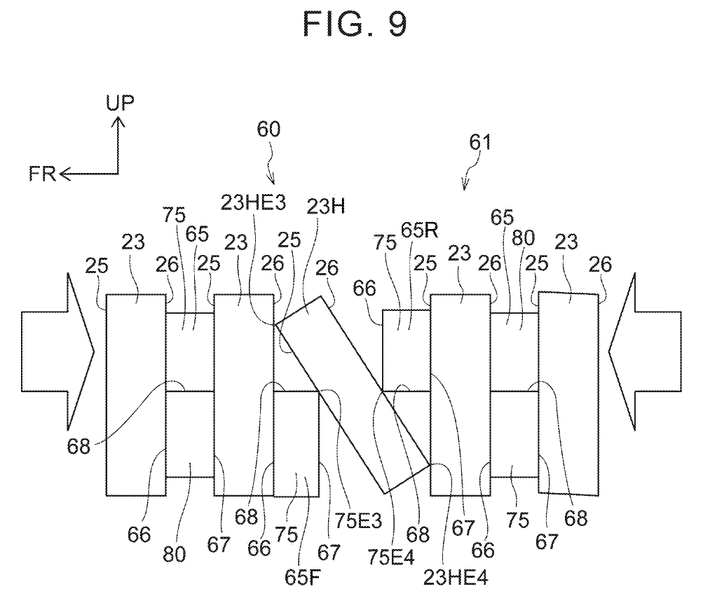

As described above, the melting point of the low melting point portion 80 is lower than that of the high melting point portion 75. Therefore, the low melting point portion 80 of the heat insulating material 65F, 65R is melted by the heat transferred from the battery cell 23H to the heat insulating material 65F, 65R, while the high melting point portion 75 of the heat insulating material 65F, 65R is not melted. When heat is further transferred from the battery cell 23H to the heat insulating material 65F, 65R, as shown in FIG. 9, the low melting point portion 80 of the heat insulating material 65F, 65R is completely melted, while the high melting point portion 75 of the heat insulating material 65F, 65R is not melted. Therefore, the area occupied by the low melting point portion 80 of the heat insulating material 65F, 65R becomes a space.

Therefore, in a plan view, the heat insulating material 65F, 65R is inclined with respect to the battery cell 23H that receives the force generated by the restraining members 57 via the heat insulating material 65F, 65R. Consequently, the front plate portion 25 of the battery cell 23H is in line contact with the rear right end corner portion 75E3 of the heat insulating material 65F, and the rear plate portion 26 of the battery cell 23H is in line contact with the front left end corner portion 75E4 of the heat insulating material 65R. Further, the right end corner portion 23HE3 on the front side of the battery cell 23H is in line-contact with the rear plate portion 26 of the battery cell 23 positioned immediately before the heat insulating material 65F. The left end corner portion 23HE4 on the rear side of the battery cell 23H is in line-contact with the front plate portion 25 of the battery cell 23 positioned immediately after the heat insulating material 65R. Further, a gap is formed between the battery cell 23H and the two battery cells 23 located on both front and rear sides of the battery cell 23H, and a gap is formed between the battery cell 23H and the heat insulating material 65F, 65R.

As described above, in the battery module 60, the right end of each battery cell 23 is positioned to the right of the boundary surface 68 of each heat insulating material 65, and the left end of each battery cell 23 is positioned to the left of the boundary surface 68 of each heat insulating material 65. Therefore, the battery cell 23H is easily inclined with respect to the heat insulating material 65F, 65R in a plan view. Further, in the battery module 60, when the low melting point portion 80 of the heat insulating material 65F, 65R is melted, the up-down direction position of the high melting point portion 75 of the heat insulating material 65F, 65R is hardly changed due to the melting of the low melting point portion 80. Therefore, it is easy to stabilize the operation in which the battery cell 23H that has undergone thermal runaway is inclined with respect to the two battery cells 23 located on both front and rear sides of the battery cell 23H.

Here, as illustrated in FIGS. 7 and 8, the contact area between the front plate portion 25 of the battery cell 23H and the heat insulating material 65F, 65R and the contact area between the rear plate portion 26 of the battery cell 23H and the heat insulating material 65F when the battery cell 23H is in surface contact with the heat insulating material 65R are defined as A0. On the other hand, as shown in FIG. 9, the contact area between the front plate portion 25 of the battery cell 23H and the heat insulating material 65F and the right end corner portion 75E3 of the rear side of the high melting point portion 75, and the contact area between the rear plate portion 26 of the battery cell 23H and the left end corner portion 75E4 of the front side of the high melting point portion 75 of the heat insulating material 65R are defined as A1. Here, the value is A0>A1, and the value obtained by dividing A1 by A0 is an extremely small value. Further, a contact area between the right end corner portion 23HE3 on the front side of the battery cell 23H and the rear plate portion 26 of the battery cell 23 positioned immediately before the heat insulating material 65F, and a contact area between the left end corner portion 23HE4 on the rear side of the battery cell 23H and the front plate portion 25 of the battery cell 23 positioned immediately after the heat insulating material 65R are defined as A2. A2 is low. For example, A2 is much smaller than A0.

In this way, the contact area A1 between the battery cell 23H and the heat insulating material 65F, 65R and the contact area A2 between the battery cell 23H and the two battery cells 23 located on both front and rear sides of the battery cell 23H in FIG. 9 are both very small in. Therefore, the amount of heat directly transferred from the battery cell 23H to the two battery cells 23 located on both front and rear sides of the battery cell 23H is small. Furthermore, the amount of heat transferred from the battery cell 23H to the two battery cells 23 located on both front and rear sides of the battery cell 23H via the heat insulating material 65F, 65R is also small. That is, the thermal resistivity between the battery cell 23H and the two battery cells 23 located on both front and rear sides of the battery cell 23H is very large. Therefore, when one battery cell 23 (23H) undergoes a thermal runaway, a thermal chain is unlikely to occur between the plurality of battery cells 23.

The inventors have experimentally confirmed that the larger the inclination angle of the battery cell 23H in a plan view, the larger the gap between the battery cell 23H and the two battery cells 23 located on both front and rear sides of the battery cell 23H, and the gap between the battery cell 23H and the heat insulating material 65F, 65R. Then, it was confirmed that the thermal resistivity between the battery cell 23H and the two battery cells 23 located on both front and rear sides of the battery cell 23H increases.

Although the battery module according to each embodiment has been described above, these can be appropriately changed in design without departing from the gist of the present disclosure.

For example, the number of battery cells included in the battery module may be any number as long as the number of battery cells is plural.

For example, the number of battery cells included in the battery module may be any number as long as the number of battery cells is plural.

The vehicles may be electrified vehicle with electric motors that are different from battery electric vehicle and utilize the power of the battery-pack. For example, the vehicles may be hybrid electric vehicle (HEV: Hybrid Electric Vehicle) or plug-in hybrid electric vehicle (PHEV: Plug-in Hybrid Electric Vehicle).

What is claimed is:

1. A battery module comprising:
a plurality of battery cells arrayed along a first direction that is predetermined;
a plurality of heat insulating materials provided between the battery cells that are adjacent, in contact with respective battery cells; and
a restraining member that exerts a force on the battery cells in a direction in which the battery cells are brought into contact with the heat insulating materials, wherein
the heat insulating materials include a high melting point portion, and a low melting point portion that is aligned with the high melting point portion along a second direction orthogonal to the first direction and of which a melting point is lower than the high melting point portion, and
in one of two of the heat insulating materials sandwiching each of the battery cells from both sides in the first direction, the high melting point portion is located further toward one side in the second direction than the low melting point portion, and in another of the two of the heat insulating materials, the high melting point portion is located further on another side in the second direction than the low melting point portion.

2. The battery module according to claim 1, wherein, as viewed along a third direction orthogonal to the first direction and the second direction, an end of a battery cell on the one side in the second direction is located on the one side from a boundary portion between the high melting point portion and the low melting point portion, and also an end of a battery cell on the other side in the second direction is located on the other side from the boundary portion.

3. The battery module according to claim 1, wherein the first direction is a lateral direction, and the second direction is an up-down direction.

4. The battery module according to claim 1, wherein the first direction and the second direction are lateral directions.

5. The battery module according to claim 1, wherein a shape of a cell case of each of the battery cells is a rectangular cuboid shape.
